(19) United States
(12) Patent Application Publication
(10) Pub. No.: US 2024/0147271 A1
(43) Pub. Date: May 2, 2024

(54) METHODS AND SYSTEMS FOR IMPROVED NETWORK LEAK DETECTION AND LOCALIZATION

(71) Applicant: COMCAST CABLE COMMUNICATIONS, LLC, Philadelphia, PA (US)

(72) Inventors: Richard Primerano, Philadelphia, PA (US); Benny Lewandowski, Philadelphia, PA (US); Richard Spanbauer, Philadelphia, PA (US); Robert Lund, Philadelphia, PA (US); Hany Fame, Philadelphia, PA (US)

(21) Appl. No.: 18/051,247

(22) Filed: Oct. 31, 2022

(51) Int. Cl. H04W 24/08; H04W 64/00

(52) U.S. Cl. CPC H04W 24/08; H04W 64/006

(57) ABSTRACT

Methods, apparatuses, and systems are described for determining one or more network leaks. Signals used to test for upstream network leaks in a hybrid fiber-coaxial (HFC) network may be output over a period of time. A detection device may determine one or more locations of one or more network leaks based on detecting the signals over the period of time.

### BACKGROUND

Network leakage monitoring is an integral and extremely important aspect of system maintenance. Federal Communications Commission (FCC) signal leakage regulations (e.g., Federal Communications Commission (FCC) regulations, FCC part 76, etc.) demand that signals (e.g., wireless signals, etc.) from and/or associated with a network (e.g., a cable network, a hybrid fiber-coaxial (HFC) network, an Internet service provider (ISP) and/or any other service provider network, etc.) adhere to basic signal leakage performance criteria (e.g., signal frequency, electric field strength, signal power level, etc.). Operators are expanding the upstream spectrum to include additional band frequencies to achieve higher upstream speeds for broadband and to manage network capacity. In standard-split plants, the primary frequency bands of interest fall in the DOCSIS downstream and were detected by having a cable modem termination system (CMTS) device generate a continuous signal that was detected by specially designed meters. In Full Duplex DOCSIS (FDX) and high-split plants, critical frequency bands now fall in the upstream, and the cable modem must generate the probe signal. Upstream leakage detection is currently achieved by detecting the DOCSIS OUDP test burst with a specially designed meter. However, building a matched filter for the entire signal is difficult because the OUDP burst is scrambled and LDPC-encoded. Although the OUDP burst contains a well-defined pilot pattern, the pilots are a small portion of the overall signal, limiting the amount of processing gain that may be achieved.

### SUMMARY

It is to be understood that both the following general description and the following detailed description are exemplary and explanatory only and are not restrictive. Methods and systems for determining signal leaks in a network are described.

A computing device (e.g., a cable modem termination system (CMTS) device, a high-speed data services device, a gateway/server device, a network device, etc.), for example, may send one or more signals (e.g., network analysis signals, orthogonal frequency-division multiplexing (OFDM) upstream data profile (OUDP) test signals, command signals, etc.) to one or more devices (e.g., cable modems, set top boxes, network devices, etc.) at one or more user premises to cause the one or more devices to generate an output of one or more signals (e.g., an upstream OFDMA signal, etc.) that may be used to determine the existence and locations of one or more leaks in a hybrid fiber-coaxial (HFC) network. The one or more signals may be defined based on a velocity of the computing device and a quantity of the one or more devices within communication range of the computing device. The locations of the one or more leaks may be determined over time as the computing device determines one or more detections of the one or more signals.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, together with the description, serve to explain the principles of the methods and systems:

FIG. 1 shows an example system for determining network leaks;

FIG. 2 shows another example system for determining network leaks;

FIG. 3A shows an example signal structure;

FIG. 3B shows an example data correlator;

FIG. 4 shows an example system;

FIG. 5 shows an example data sample;

FIG. 6 shows a flowchart of an example method;

FIG. 7 shows a flowchart of an example method;

FIG. 8 shows a flowchart of an example method;

FIG. 9 shows a flowchart of an example method; and

FIG. 10 shows a block diagram of a computing device for implementing the example methods.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It may be understood that this language may in some cases mean that a system (e.g., a computer) owned and/or controlled by the given entity is actually performing the action.

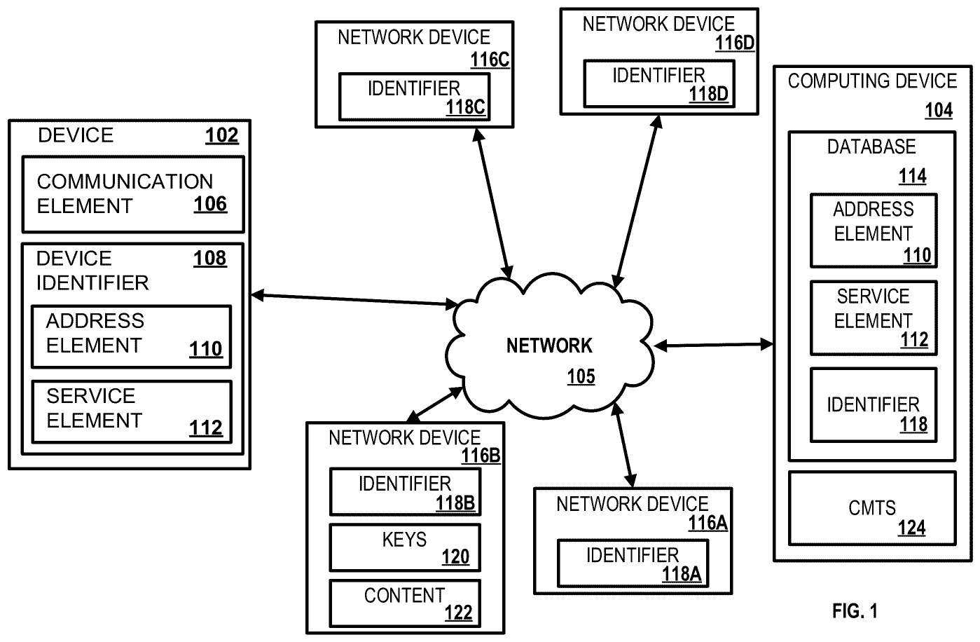

FIG. 1 shows an example system 100 for locating network leaks based on the output of one or more signals by one or more devices. For example, the system 100 may be configured to cause one or more devices (e.g., network devices 116A-116D) to output one or more signals. The system 100 may be configured to provide services, such as network-related services, to a device (e.g., device 102, network devices 116A-116D, etc.). The network and system may comprise at least one device 102 in communication with a plurality of network devices 116A-116D and/or a computing device 104, such as a server, for example, via network 105. The computing device 104 may be disposed locally or remotely relative to the device 102 and the network devices 116A-116D. As an example, the device 102, network devices 116A-116D, and the computing device 104 can be in communication via a private and/or public network 105 such as the Internet or a local area network (LAN). Other forms of communications can be used such as wired and wireless telecommunication channels, for example.

The device 102 may comprise one or more user devices. The user devices may comprise electronic devices such as computers, smartphones, laptops, tablets, set top boxes, display devices, or other devices capable of communicating with the network devices 116A-116D and/or the computing device 104. As an example, the device 102 may comprise a communication element 106 for providing an interface to a user to interact with the device 102 and/or the computing device 104. The communication element 106 may be any interface for presenting and/or receiving information to/from the user, such as user feedback. An example interface may be a communication interface such as a web browser (e.g., Internet Explorer®, Mozilla Firefox, Google Chrome®, Safari®, or the like). Other software, hardware, and/or interfaces can be used to provide communication between the user and one or more of the device 102, the network devices 116A-116D, and/or the computing device 104. As an example, the communication element 106 may request or query various files from a local source and/or a remote source. As a further example, the communication element 106 may transmit data to a local or remote device such as the network devices 116A-116D and/or the computing device 104.

The device 102 may be associated with a user identifier or a device identifier 108. As an example, the device identifier 108 may be any identifier, token, character, string, or the like, for differentiating one user or user device from another user or user device. As a further example, the device identifier 108 may identify a user or user device as belonging to a particular class of users or user devices. As a further example, the device identifier 108 may comprise information relating to the device 102 such as a manufacturer, a model or type of device, a service provider associated with the device 102, a state of the device 102, a locator, and/or a label or classifier. Other information can be represented by the device identifier 108.

The device identifier 108 may comprise an address element 110 and a service element 112. The address element 110 may comprise or provide an internet protocol address, a network address, a media access control (MAC) address, international mobile equipment identity (IMEI) number, international portable equipment identity (IPEI) number, an Internet address, or the like. As an example, the address element 110 may be relied upon to establish a communication session between the device 102 and the network devices 116A-116D and/or the computing device 104 or other devices and/or networks. As a further example, the address element 110 may be used as an identifier or locator of the device 102. In an example, the address element 110 may be persistent for a particular network.

The service element 112 may comprise identification of the service providers associated with the device 102, with the class of device 102, and/or with a particular network 105 with which the device 102 is currently accessing services associated with the service providers. The class of the device 102 may be related to a type of device, capability of device, type of service being provided, and/or a level of service (e.g., business class, service tier, service package, etc.). As an example, the service element 112 may comprise information relating to or provided by a communication service provider (e.g., Internet service provider) that is providing or enabling data flow such as communication services to the device 102. As a further example, the service element 112 may comprise information relating to a preferred service provider for one or more particular services relating to the device 102. In an example, the address element 110 may be used to identify or retrieve data from the service element 112, or vice versa. As a further example, one or more of the address element 110 and the service element 112 may be stored remotely from the device 102 and retrieved by one or more devices such as the device 102 and the computing device 104. Other information may be represented by the service element 112.

The device 102 may be configured with and/or located within, for example a vehicle. The vehicle may be any type of vehicle, mobile device, and/or moving object, such as a car, a bicycle, an autonomous vehicle/drone, an aircraft, a watercraft, human-powered and/or facilitated mobility, and/or the like. The vehicle and/or device 102 may travel a path. The path may be, for example, a service area of and/or supported by the headend (e.g., computing device 104). The device 102 may be configure with a global positioning system (GPS) sensor/antenna configured to, either periodically or consistently, determine and/or record the location (e.g., current GPS coordinates, etc.) of the device 102. The device 102 may also be synchronized to a GPS clock to establish timing consistent with the timing communicated with the computing device 104. The device 102 may include a velocity meter, an accelerometer, a positioning sensor, and/or the like configured to, either periodically or consistently, determine the velocity, speed, and/or orientation of the device 102. The device 102 may send the computing device 104 location information that includes a location (e.g, GPS coordinates, etc.) of the device 102 and a travel speed (e.g., velocity, etc.) of the device 102 and timing information associated with one or more determined/detected network leaks.

The device 102 may be configured to communicate with the computing device 104 to receive location information (e.g., GPS coordinates, etc.) associated with one or more user devices (e.g., network devices 116A-116D) along the path. For example, the device 102, based on the location information associated with the device 102, may determine that the computing device 104 (and/or the device 102) is in proximity to and/or services the user devices (e.g., network devices 116A-116D) along the path. The device 102 may receive information from the computing device 104 that includes, for example, the number of user devices (e.g., network devices 116A-116D) along the path, the type of user devices (e.g., network devices 116A-116D), configuration details associated with the user devices (e.g., network devices 116A-116D), the location information associated with the user devices (e.g., network devices 116A-116D), and/or any other information associated with the user devices (e.g., network devices 116A-116D).

Network leak location information may be determined by, for example, the device 102. The device 102 may be configured to cause the one or more user devices (e.g., network devices 116A-116BD) to output one or more signals for locating one or more network leaks. As an example, the device 102 may be configured to send instructions for upstream transmissions to the computing device 104 for the computing device 104 to cause the one or more user devices (e.g., network devices 116A-116D) to output the one or more signals. The one or more signals may be based on an orthogonal frequency division multiple access upstream data profile (OUDP) test burst. Each signal of the one or more signals may comprise a pulse signal of two or more pulses output at an interval over a period of time. The device 102 may determine one or more parameters of the one or more signals to be output by the one or more user devices (e.g., network devices 116A-116D) based on a velocity of the device 102 and a quantity of the one or more user devices (e.g., network devices 116A-116D) within a communication range of the computing device. The one or more parameters may comprise at least one of an interval each signal is output over a period of time, a pulse width of each signal, a pulse repetition period of each signal, or a number of pulses of each signal to output. The interval each signal is output over the period of time may be determined based on a velocity associated with the device 102. For example, the interval may be proportional to the velocity or may be adjusted based on the velocity. The device 102 may determine the one or more user devices (e.g., network devices 116A-116D) to output the one or more signals based on location information comprising a location associated with the one or more devices. The device 102 may cause the one or more user devices (e.g., network devices 116A-116D) to output the one or more signals based on the one or more parameters. The device 102 may determine one or more locations of one or more network leaks based on a detection of the one or more signals. For example, the device 102 may determine a location associated with each detection of a plurality of detections of each signal of the one or more signals over a period of time based on a velocity of the device 102 over the period of time associated with each detection. The device 102 may determine the one or more locations of one or more network leaks based on a correlation of each location associated with each detection of each signal over the period of time. For example, each detection of a plurality of detections of each signal, over the period of time, may be correlated to each other. Thus, the accuracy of the location of each signal (and thus, each network leak) increases with each detection.

The device 102 may be configured to enable the one or more signals, for example, only when needed. The device 102 may schedule the output of the one or more signals based on, for example, the location and velocity (e.g., travel speed) of the device 102 and the information associated with the one or more user devices (e.g., network devices 116A-116D). For example, the scheduling of the one or more signals may be used to ensure that at least one and/or each of the one or more user devices (e.g., network devices 116A-116D) generate/output at least one signal of the one or more signals that may be used for leak detection as the device 102 passes through the service area.

The device 102, the network devices 116A-116D, and the computing device 104 may communicate between each other via network 105. The network 105, may include a packet-switched network (e.g., an Internet protocol-based network), a non-packet switched network (e.g., quadrature amplitude modulation-based network), and/or the like. The network 105 may include network adapters, switches, routers, modems, and the like connected through wireless links (e.g., radio frequency, satellite, etc.) and/or physical links (e.g., fiber optic cable, coaxial cable, Ethernet cable, or a combination thereof). The network 105 may include public networks, private networks, wide area networks (e.g., Internet), local area networks, and/or the like. The network 105 may include a content access network, a content distribution network, and/or the like. The network 105 may be configured to provide communication from telephone, cellular, modem, and/or other electronic devices to and throughout the system 100. The network may include, for example, a hybrid fiber-coaxial (HFC) network. For example, the network 105 may employ and/or facilitate various methods for sending desired signals over a coaxial cable such as any version of Data Over Cable Service Interface Specification (DOCSIS). The network 105 may support and/or facilitate low-split, mid-split, high-split, Full Duplex DOCSIS (FDX), and Extended Spectrum DOCSIS (ESD) configurations. For a low-split configuration, the network 105 may support/facilitate upstream frequencies below 42 MHz and/or the like. For a mid-split configuration, the network 105 may support/facilitate frequency division schemes that facilitate bi-directional traffic on a single coaxial cable, where reverse channel signals propagate to a headend (e.g., computing device 104), for example, from 5 to 85 MHz, and where forward path signals go from the headend (e.g., computing device 104) from 102 MHz to the upper frequency limit. A duplex crossover band may be located from 85 to 102 MHz. For a high-split configuration, the network 105 may support/facilitate downstream frequencies of 258-1002 MHz and upstream frequencies of 5-204 MHz. With the increased bandwidth of the high-split configuration in the upstream direction, the Aeronautical Frequency Band (108-137 MHz) that was in the downstream direction in low-split and mid-split networks may reside in the upstream spectrum. For FDX and ESD configurations, the network 105 may support/facilitate downstream frequencies up to 1800 MHz and upstream frequencies up to 684 MHz.

The computing device 104 may comprise a server for communicating with the device 102 and/or the network devices 116A-116D. As an example, the computing device 104 may communicate with the device 102 and/or network devices 116A-116D for providing data and/or services. As an example, the computing device 104 may provide services, such as network (e.g., Internet) connectivity, network printing, media management (e.g., media server), content services, streaming services, broadband services, or other network-related services. The computing device 104 may allow the device 102 to interact with remote resources, such as data, devices, and files. As an example, the computing device 104 may be configured as (or disposed at) a central location (e.g., a headend, or processing facility), which may receive content (e.g., data, input programming) from multiple sources. The computing device 104 may combine the content from the multiple sources and may distribute the content to user (e.g., subscriber) locations via a distribution system. For example, the computing device 104 may be configured to receive, process, and distribute content and/or media signals, such as video signals, audio signals, and data signals within the network 105.

The computing device 104 may be maintained and/or managed by a content and/or a media service provider, such as a cable television (CATV) provider or an Internet service provider (ISP). The computing device 104 may include any reasonably suitable electrical equipment for receiving, storing, and/or re-transmitting content/media signals, such as content/media servers, satellite receivers, modulators/demodulators, edge decoders, and/or the like. For example, the computing device 104 may include a cable modem termination system (CMTS) 124.

The CMTS 124 may be configured as an intermediary between the network devices 116A-116D (e.g., cable modems, multimedia terminal adapters (MTA), set-top boxes, network terminals, etc.) and a backbone network/portion (e.g. the Internet) of the network 105. The CMTS 124 may forward/send data received from a backbone network to the network devices 116A-116D and forward data received from the network devices 116A-116D onto the backbone network. The CMTS 124 may comprise an optical transmitter and an optical receiver for transmitting and/or receiving messages from the network devices 116A-116D. The CMTS 124 may include transmitters and/or receivers for communicating with the backbone network. The CMTS 124 may include a converter that may convert any protocol used within the backbone network to a protocol suitable for data communication with the network devices 116A-116D. For example, the CMTS 124 may send/transmit signals (e.g., media signals, broadband signals, content signals, etc.) downstream to the network devices 116A-116D via a fiber-optic connection/communication link to a fiber optic node supporting the network devices 116A-116D. The fiber optic node may, for example, receive and convert optical signals sent from the computing device 104 to RF signals that are sent to the network devices 116A-116D via distributed taps (e.g., subscriber taps, etc.) distributed via coaxial cables to the network devices 116A-116D, respectively.

The computing device 104 may be configured to manage the communication between the device 102, and/or network devices 116A-116D, and a database 114 for sending and receiving data therebetween. As an example, the database 114 may store a plurality of files (e.g., web pages), user identifiers or records, or other information. As a further example, the device 102 may request and/or retrieve a file from the database 114. The database 114 may store information relating to the device 102 such as the address element 110 and/or the service element 112. As an example, the computing device 104 may obtain a device identifier 108 from the device 102 and retrieve information from the database 114 such as the address element 110 and/or the service element 112. As a further example, the computing device 104 may obtain the address element 110 from the device 102 and may retrieve the service element 112 from the database 114, or vice versa. Any information may be stored in and retrieved from the database 114. The database 114 may be disposed remotely from the computing device 104 and accessed via direct or indirect connection. The database 114 may be integrated with the computing device 104 or some other device or system.

The computing device 104 may be configured to receive instructions from the device 102 for upstream transmissions for the computing device 104 to cause one or more user devices (e.g., network devices 116A-116D) to output one or more signals for determining the location of the network leaks. The one or more signals may be based on an orthogonal frequency division multiple access upstream data profile (OUDP) test burst. Each signal of the one or more signals may comprise a pulse signal of two or more pulses output at an interval over a period of time. The computing device 104 may receive one or more parameters of the one or more signals to be output by the one or more user devices (e.g., network devices 116A-116D) from the device 102. For example, the device 102 may determine one or more parameters of the one or more signals to be output by the one or more user devices (e.g., network devices 116A-116D) based on a velocity of the device 102 and a quantity of the one or more user devices (e.g., network devices 116A-116D) within a communication range of the device 102, and send the one or more parameters to the computing device 104. The one or more parameters may comprise at least one of an interval each signal is output over a period of time, a pulse width of each signal, a pulse repetition period of each signal, or a number of pulses of each signal to output. The interval each signal is output over the period of time may be determined based on a velocity associated with the device 102. As an example, the interval each signal is output over the period of time may be proportional to the velocity. As a further example, the interval each signal is output over the period of time may be adjusted based on the velocity. For example, the interval for outputting the signal may be decreased as the velocity increases or the interval for outputting the signal may be increased as the velocity decreases. The device 102 may determine the one or more user devices (e.g., network devices 116A-116D) to output the one or more signals based on location information comprising a location associated with the one or more user devices (e.g., network devices 116A-116D). The device 102 may send instructions to the computing device 104 to instruct the computing device 104 to cause the one or more user devices (e.g., network devices 116A-116D) to output the one or more signals based on the one or more parameters. The device 102 may determine one or more locations of one or more network leaks based on a detection of the one or more signals. For example, the device 102 may determine a location associated with each detection of a plurality of detections of each signal of the one or more signals over a period of time based on a velocity of the device 102 over the period of time associated with each detection. The device 102 may then determine the one or more locations of one or more network leaks based on a correlation of each location associated with each detection of each signal over the period of time. For example, each detection of a plurality of detections of each signal, over the period of time, may be correlated to each other. Thus, the accuracy of the location of each signal (and thus, each network leak) increases with each detection.

The network devices 116A-116D may be any device configured to communicate with the computing device 104, including the CMTS 124, for example, within a local network of the respective users/subscribers premises. For example, the network devices 116A-116D may be configured to interface with a display, an Internet of Things (IoT) device, a mobile device, one or more sensors, and/or the like. For example, the network devices 116A-116D may comprise user premises devices such as set top boxes, cable boxes, routers, cable modems, multimedia terminal adapters (MTA), network terminals, or any combination thereof. The network devices 116A-116D may be configured to interface with any local network device with an Internet Protocol (IP) and/or Media Access Control (MAC) address, such as a local computer, a wired and/or wireless router, a local content server, and/or the like. The network devices 116A-116D may forward data/information received from the computing device 104/CMTS 124 to any devices, for example, within a local network of the respective users/subscribers premises, and may forward data received from any device to the computing device 104/CMTS 124. The specific configuration of the network devices 116A-116D may vary. Each of the network devices 116A-116D may include a converter that may convert signals and/or data/information to signals and/or data/information suitable for any devices, for example, within a local network of the respective users/subscribers premises.

The network devices 116A-116D may be configured to facilitate the connection of a user device (e.g., devices within a user's home) to the network 105. For example, the network devices 116A-116D may be configured as wireless access points (WAPs). The network devices 116A-116D may be configured to allow one or more wireless devices to connect to a wired and/or wireless network using Wi-Fi, Bluetooth®, Zigbee®, or any desired method or standard.

The network devices 116A-116D may comprise identifiers 118A-118D. As an example, one or more identifiers may be, or relate to, an Internet Protocol (IP) Address IPV4/IPV6 or a media access control address (MAC address) or the like. As a further example, the identifiers 118A-118D may be unique identifiers for facilitating communications on the physical network segment. Each of the network devices 116A-116D may comprise an identifier 118A-118D that is distinct. As an example, the identifiers 118A-118D may be associated with a physical location of the network devices 116A-116D.

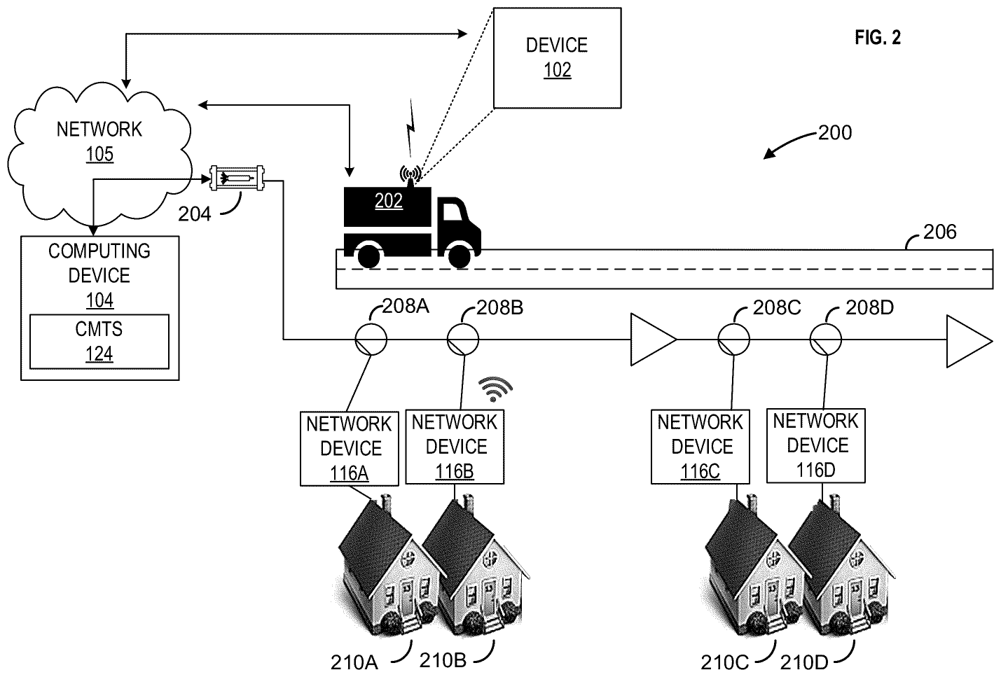

FIG. 2 shows an example system 200. The system may include network 105. The device 102, the network devices 116A-116D, and the computing device 104 may communicate between each other via the network 105. The device 102 may be configured with and/or located within a vehicle 202. The vehicle 202 may be any type of vehicle, mobile device, and/or moving object, such as a car, a bicycle, an autonomous vehicle/drone, an aircraft, a watercraft, human-powered and/or facilitated mobility, and/or the like. Although the device 102 is shown to be configured with the vehicle 202, the device 102 may be configured and/or associated with any type of device, such as a mobile device, a smart device, a computing device, a personal computing device, and/or the like.

The vehicle 202 and/or the device 102 may travel along a path 206. The path 206 may be, for example, a service area of and/or supported by the CMTS 124. The device 102 may be configure with a global positioning system (GPS) sensor/antenna configured to, either periodically or consistently, determine and/or record the location (e.g., current GPS coordinates, etc.) of the device 102. The device 102 may also be synchronized to a GPS clock to establish timing consistent with the timing communicated with the computing device 104. The device 102 may include a velocity meter, an accelerometer, a positioning sensor, and/or the like configured to, either periodically or consistently, determine the velocity, speed, and/or orientation of the device 102. The device 102 may send the computing device 104 location information that includes a location (e.g, GPS coordinates, etc.) of the device 102 and a travel speed (e.g., velocity, etc.) of the device 102 and timing information associated with one or more determined/detected network leaks.

The device 102 may be configured to communicate with the computing device 104 to receive location information (e.g., GPS coordinates, etc.) associated with the network devices 116A-116D along the path 206. For example, the device 102, based on the location information associated with the device 102, may determine that the computing device 104 (and/or the device 102) is in proximity to and/or services the network devices 116A-116D along the path 206. The device 102 may receive information from the computing device 104 that includes, for example, the number of network devices 116A-116D along the path 206, the type of network devices 116A-116D, configuration details associated with the network devices 116A-116D, the location information associated with the network devices 116A-116D, and/or any other information associated with the network devices 116A-116D.

Network leak location information may be determined by, for example, the device 102 as the device 102 travels along the path 206. The device 102 may be configured to cause one or more network devices 116A-116BD to output one or more signals for locating one or more network leaks. As an example, the device 102 may be configured to send instructions for upstream transmissions to the computing device 104 for the computing device 104 to cause the one or more network devices 116A-116D to output the one or more signals. The one or more signals may be based on an orthogonal frequency division multiple access upstream data profile (OUDP) test burst. Each signal of the one or more signals may comprise a pulse signal of two or more pulses output at an interval over a period of time. The device 102 may determine one or more parameters of the one or more signals to be output by the one or more network devices 116A-116D based on a velocity of the device 102 and a quantity of the one or more network devices 116A-116D within a communication range of the device 102. The one or more parameters may comprise at least one of an interval each signal is output over a period of time, a pulse width of each signal, a pulse repetition period of each signal, or a number of pulses of each signal to output. The interval each signal is output over the period of time may be determined based on a velocity associated with the device 102. For example, the interval may be proportional to the velocity or may be adjusted based on the velocity. The device 102 may determine the one or more network devices 116A-116D to output the one or more signals based on location information comprising a location associated with the one or more devices. The device 102 may cause the one or more network devices 116A-116D to output the one or more signals based on the one or more parameters. The device 102 may determine one or more locations of one or more network leaks based on a detection of the one or more signals. For example, as the device travels along the path 206, the device 102 may determine a location associated with each detection of a plurality of detections of each signal of the one or more signals over a period of time based on a velocity of the device 102 over the period of time associated with each detection. The device 102 may determine the one or more locations of one or more network leaks based on a correlation of each location associated with each detection of each signal over the period of time. For example, each detection of a plurality of detections of each signal, over the period of time, may be correlated to each other. Thus, the accuracy of the location of each signal (and thus, each network leak) increases with each detection.

The CMTS 124 may be an intermediary between the network devices 116A-116D (e.g., cable modems, multimedia terminal adapters (MTA), set-top boxes, network terminals, etc.) and a backbone network/portion (e.g. the Internet) of the network 105. The CMTS 124 may forward/send data received from a backbone network to the network devices 116A-116D and forward data received from the network devices 116A-116D onto the backbone network. The CMTS 124 may comprise an optical transmitter and an optical receiver for transmitting and/or receiving messages from the network devices 116A-116D. The CMTS 124 may include transmitters and/or receivers for communicating with the backbone network. The CMTS 124 may include a converter that may convert any protocol used within the backbone network to a protocol suitable for data communication with the network devices 116A-116D. For example, the CMTS 124 may, send/transmit signals (e.g., media signals, broadband signals, content signals, etc.) downstream to users/subscribers 210A-210D, via a fiber-optic connection/communication link to a fiber optic node 204 supporting the users/subscribers 210A-210D. The fiber optic node 204 may, for example, receive and convert optical signals sent from the computing device 104 to RF signals that are sent to the users/subscribers 210A-210D via distributed taps 208A-208D (e.g., subscriber taps, etc.) distributed via coaxial cables to the network devices 116D-116D, respectively.

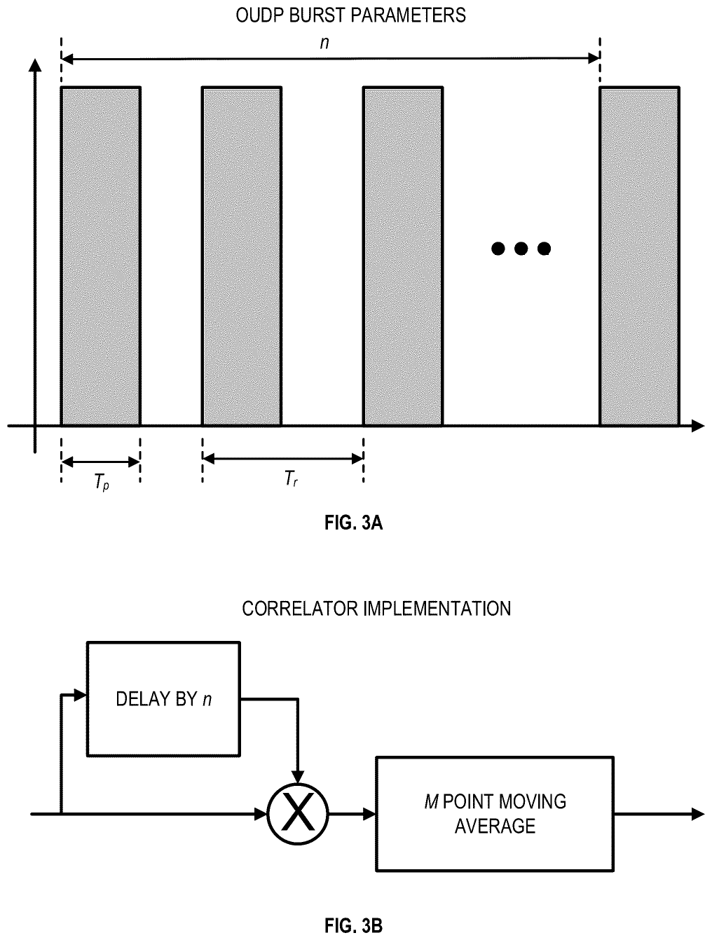

FIG. 3A shows an example signal structure of the pulse signal that may be output by the one or more user devices (e.g., network devices 116A-116D). The OUDP burst shown in FIG. 3A may consist of a series of identical pulses transmitted at a specified period. The waveform may have a first autocorrelation peak at a lag of Tᵣ. The phase of this peak provides a Doppler frequency estimate, allowing an estimate of the velocity between the (stationary) leak and the detector (e.g., device 102). The waveform may be defined by one or more parameters such as an OUDP burst width (Tₚ), a burst repetition period (Tᵣ), and a number of transmitted bursts (n). Each of these parameters may impact the detection sensitivity and Doppler resolution, enabling the waveform parameters to be customized based on the RF environment (e.g., rural area vs. urban area). The pulse width (Tₚ) parameter sets the detection sensitivity. The relationship between the pulse width, signal bandwidth, and processing gain is approximately PG 2=10 log (Tₚ*BW). For example, using the typical values of Tₚ=5 ms and BW=1.6 MHz, PG=10 log(8000)=39 dB. The value of the pulse repetition period (Tᵣ) sets the maximum unambiguous velocity that may be measured, vₘₐₓ=λ/2Tᵣ. For example, when both the transmitter and receiver are stationary, the phase of the autocorrelator's output peak is zero. If there is relative motion between the two, the phase will be non-zero. The phase of the peak encodes the distance (in wavelengths) the receiver has traveled between pulses. The receiver may travel no more than one half of a wavelength between pulses for unambiguous measurement. For example, using typical values of Tᵣ=50 ms and λ=2.3 meters (f=130 MHz), vₘₐₓ=23 m/s=51 mph. The minimum number of pulses (n) that can be transmitted is two, resulting in a single peak at the detector. Transmitting n pulses results in n−1 detection events. If the relative motion between the transmitter and the receiver is constant over the duration of pulses, the detection events can be coherently averaged to form a single effective detection. In an example, the overall processing gain becomes PGₙ=10 log(n−1)+PG₂. For example, transmitting n=5 pulses gives a 6 dB increase in processing gain over the two-pulse burst.

FIG. 3B shows an example data correlator. The detector may calculate the autocorrelation of the signal at a 50 ms lag, which is the known OUDP pulse repetition period. Effectively, one pulse within the pulse signal may become the matched filter of the next pulse (e.g., with some noise added). The potential processing gain=10*log(pulse width*bandwidth) (e.g., for a 5 ms pulse at 1.6 MHz=39 dB). The autocorrelation-based detection method may be “blind,” and thus, requires no knowledge of the transmitted signal and is sensitive only to the repetition within the signal. However, a signal exhibiting a repetition of length T r may pass through the detection, appearing as interference. The one or more OUDP leakage burst parameters may be tuned/adjusted based on background interference characteristics to minimize their impact on detector performance. For example, the waveform parameter selection may be tuned based on the environment (e.g., urban environment vs. rural environment). In a dense urban environment where there may be several cable modems in RF range, within a close proximity to the receiver's path of travel, a narrow pulse width (Tₚ) may be used. This results in low sensitivity. However, a larger number of devices may be scheduled to output the one or more signals in a fixed time interval. Since homes may be near the road, RF path loss and the sensitivity loss may be acceptable. In a sparse rural environment where there are few cable modems in RF range, far away from the receiver's path of travel, a wide pulse width (Tₚ) may be used. This may result in a high sensitivity. However, fewer devices may be scheduled to output the one or more signals in a fixed time interval. Since homes may be far away from the road, the high sensitivity pulse may overcome the RF path loss.

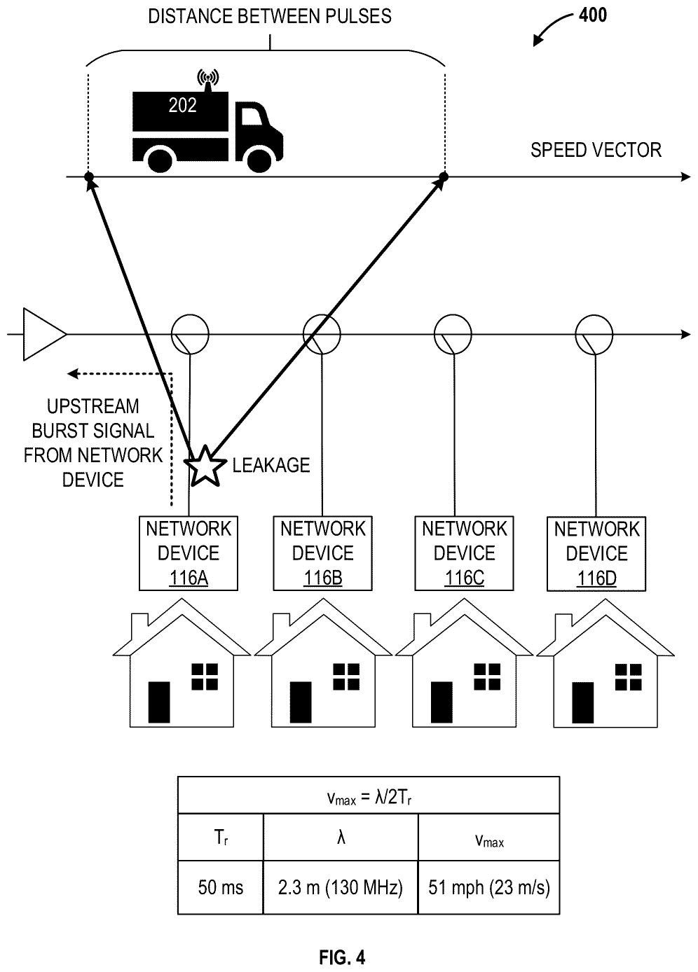

FIG. 4 shows an example system 400 comparing the maximum velocity and distance a vehicle may travel between pulses for unambiguous measurements of the pulse signal. For example, the maximum velocity (vₘₐₓ) that may be measured may be based on the pulse repetition period (Tᵣ). For example, the maximum velocity (vₘₐₓ) may be determined based on the equation, vₘₐₓ=λ/2Tᵣ, wherein λ represents the distance the receiver travels between pulses. Thus, using typical values of 50 ms for the pulse repetition period (Tᵣ) and 2.3 meters for the distance the receiver may travel between pulses (λ), the maximum velocity (vₘₐₓ) that may be measured as the receiver travels along the path in order to detect the pulse signal is 23 m/s, or 51 mph. In an example, in situations where velocity ambiguity may occur, the pulse repetition period (Tᵣ) may be varied from one pulse burst to the next, similar to the staggered Pulse Repetition Frequency (PRF) waveforms used in radar for Doppler ambiguity resolution, in order to resolve the ambiguity.

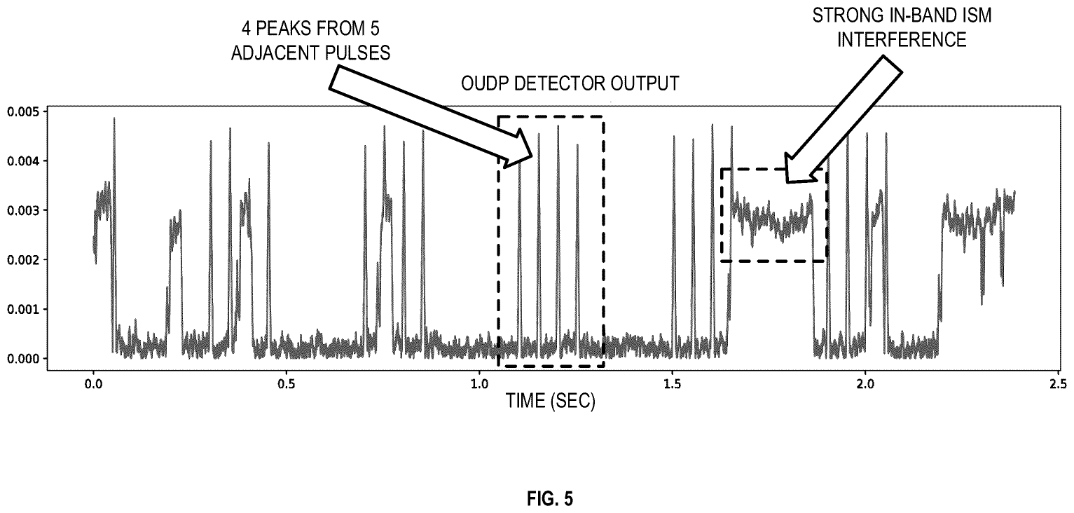

FIG. 5 shows an example data sample of a detected signal. For example, the signal may be detected by a device during a “quiet” period. However, as shown in FIG. 5, in addition to the four autocorrelation peaks per burst associated with the output of at least one pulse signal (e.g., OUDP burst), the signal may contain some in-band interferences (e.g., ISM interferences). However, the sequential transmission of identical pulses within the pulse signal (e.g., OUDP waveform) allows for the increased ability to identify the pulse signal within the received signal, as shown in FIG. 5, for example. For example, the pulse signal may comprise two or more pulses output at an interval over a period of time. One pulse within the pulse signal may become the match filter of the next pulse, and thus, enabling the autocorrelation-based detection method to detect the pulse signal without requiring any knowledge of the transmitted signal since the method is sensitive to the repetition within the pulse signal.

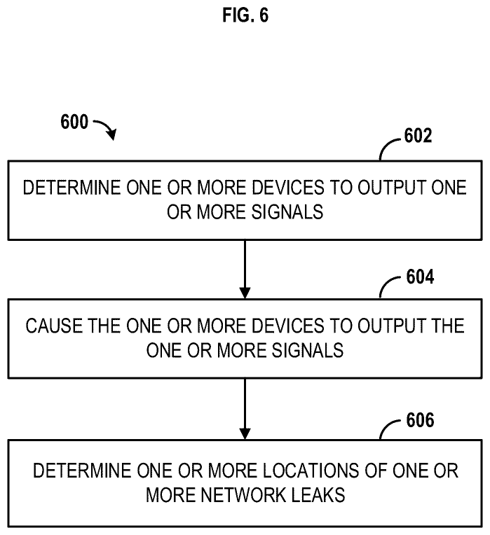

FIG. 6 shows a flowchart of an example method 600 for determining signal leaks within a network. For example, the method 600 may be used to determine one or more network leaks based on upstream data/traffic in an HFC network. Upstream leak detection test signaling output by user devices (e.g., cable modems, multimedia terminal adapters (MTA), set-top boxes, network terminals, the network devices 116A-116D, etc.), for example, within a service group and/or service area of a network device (e.g., a cable modem termination system (CMTS), a virtual CMTS, a headend device, etc.), such as an OUDP burst test signal and/or the like, may be interleaved with data, such as broadband data, customer traffic, content, and/or the like, and used to determine the existence of signal leaks in the network. For example, a signal caused to be output by a user device may be interleaved with broadband data, customer traffic, content, and/or the like, so that the actual signal that is a potential leak source in the HFC network is the same signal that is detected, for example, by the leak detection device.

At step 602, one or more parameters of one or more signals may be determined. The one or more parameters may comprise at least one of an interval each signal of the one or more signals is output over a period of time, a pulse width of each signal of the one or more signals, a pulse repetition period of each signal of the one or more signals, or a number of pulses of each signal of the one or more signals to output. The one or more parameters may be determined based on a velocity of a computing device and a quantity of one or more devices within communication range of the computing device. As an example, the interval that each pulse signal is output may be determine based on a velocity of the computing device. For example, the interval may be proportional to the velocity of the computing device or the interval may be adjusted based on the velocity of the computing device. As a further example, the parameters may be determined based on the environment. For example, in a dense urban environment where there may be several devices in RF range, in close proximity to a computing/detection device's travel path, a narrow pulse width may be used. In a sparse rural environment where there are few devices in RF range, far away from the computing/detection device's travel path, a wide pulse width may be used. The one or more signals may be based on an orthogonal frequency division multiple access upstream data profile (OUDP). Each signal of the one or more signals may comprise a pulse signal comprising two or more pulses output at an interval over a time period. The minimum number of pulses that can be transmitted is two, resulting in a single peak at the detector. Essentially, one pulse within the pulse signal may become the match filter of the next pulse, and thus, enabling the autocorrelation-based detection method to detect the pulse signal without requiring any knowledge of the transmitted signal since the method is sensitive to the repetition within the pulse signal. In an example, one or more devices may be determined for outputting the one or more signals. The one or more devices may be determined based on location information. For example, the one or more devices may be determined based on an area or location comprising the one or more devices such as a cable service area wherein the one or more devices are located.

At step 604, one or more devices may be caused to output the one or more signals based on the one or more parameters. At step 606, one or more locations of one or more network leaks may be determined based on a detection of the one or more signals. For example, a location associated with each detection of a plurality of detections of each signal may be determined based on the velocity of the computing/detection device over a period of time associated with each detection. The one or more locations of the one or more network leaks may be determined based on a correlation of each location associated with each detection over the period of time. For example, each detection of a plurality of detections of each signal, over the period of time, may be correlated to each other. Thus, the accuracy of the location of each signal (and thus, each network leak) increases with each detection.

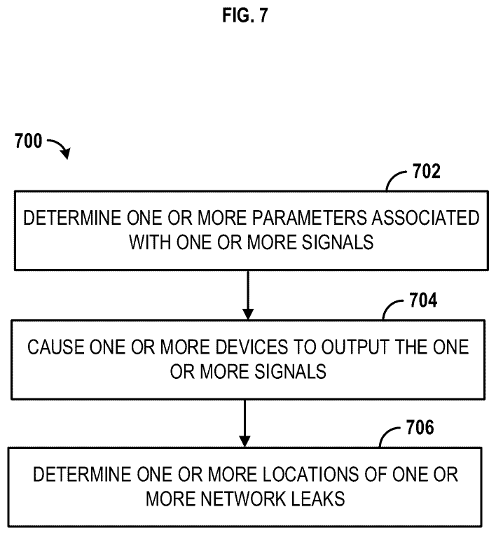

FIG. 7 shows a flowchart of an example method 700 for determining signal leaks within a network. For example, the method 700 may be used to determine one or more network leaks based on upstream data/traffic in an HFC network. At step 702, one or more parameters of one or more signals may be determined based on location information and velocity information. The one or more parameters may comprise at least one of an interval each signal of the one or more signals is output over a period of time, a pulse width of each signal of the one or more signals, a pulse repetition period of each signal of the one or more signals, or a number of pulses of each signal of the one or more signals to output. The location information may comprise information indicative of a location associated with the one or more devices and a density, or quantity, of the one or more devices within the location. In an example, the location may comprise a cable service area wherein the one or more devices are located. The velocity information may comprise information indicative of a velocity associated with the computing device. The location information and the velocity information may be received from the computing/detection device performing the network leakage detection process.

The one or more signals may be based on an orthogonal frequency division multiple access upstream data profile (OUDP). Each signal of the one or more signals may comprise a pulse signal comprising two or more pulses output at an interval over a time period. The minimum number of pulses that can be transmitted is two, resulting in a single peak at the detector. Essentially, one pulse within the pulse signal may become the match filter of the next pulse, and thus, enabling the autocorrelation-based detection method to detect the pulse signal without requiring any knowledge of the transmitted signal since the method is sensitive to the repetition within the pulse signal. As an example, the interval that each pulse signal is output may be determined based on the velocity information. As a further example, the parameters may be determined based on the location information. For example, in a dense urban environment where there may be several devices in RF range, in close proximity to a computing/detection device's travel path, a narrow pulse width may be used. In a sparse rural environment where there are few devices in RF range, far away from the computing/detection device's travel path, a wide pulse width may be used.

At step 704, one or more devices may output the one or more signals based on the one or more parameters. At step 706, one or more locations of one or more network leaks may be determined based on a detection of the one or more signals. For example, a location associated with each detection of a plurality of detections of each signal may be determined based on the velocity of the computing device over a period of time associated with each detection. The one or more locations of the one or more network leaks may be determined based on a correlation of each location associated with each detection. For example, each detection of a plurality of detections of each signal, over the period of time, may be correlated to each other. Thus, the accuracy of the location of each signal (and thus, each network leak) increases with each detection.

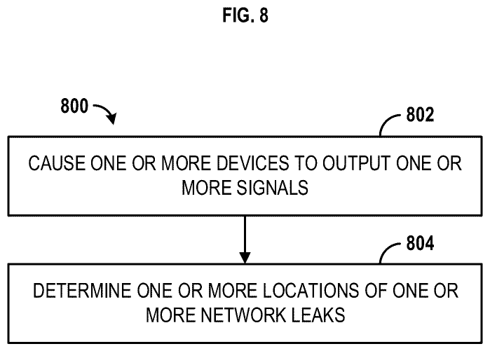

FIG. 8 shows a flowchart of an example method 800 for determining signal leaks within a network. For example, the method 800 may be used to determine one or more network leaks based on upstream data/traffic in an HTC network. At step 802, one or more devices may be caused to output one or more signals over a period of time according to one or more parameters associated with location information and velocity information. The one or more signals may be based on an orthogonal frequency division multiple access upstream data profile (OUDP). Each signal of the one or more signals may comprise a pulse signal comprising two or more pulses output at an interval over a time period. The minimum number of pulses that can be transmitted is two, resulting in a single peak at the detector. Essentially, one pulse within the pulse signal may become the match filter of the next pulse, and thus, enabling the autocorrelation-based detection method to detect the pulse signal without requiring any knowledge of the transmitted signal. The detection method is sensitive to the repetition within the pulse signal. The one or more parameters may comprise at least one of an interval each signal of the one or more signals is output over a period of time, a pulse width of each signal of the one or more signals, a pulse repetition period of each signal of the one or more signals, or a number of pulses of each signal of the one or more signals to output. The location information may comprise information indicative of a location associated with the one or more devices and a density, or quantity, of the one or more devices within the location. In an example, the location may comprise a cable service area wherein the one or more devices are located. The velocity information may comprise information indicative of a velocity associated with the computing device. As an example, the interval that each pulse signal is output may be determined based on the velocity information. As a further example, the parameters may be determined based on the location information. For example, in a dense urban environment where there may be several devices in RF range, in close proximity to a computing/detection device's travel path, a narrow pulse width may be used. In a sparse rural environment where there are few devices in RF range, far away from the computing/detection device's travel path, a wide pulse width may be used.

At step 804, one or more locations of one or more network leaks may be determined based on a correlation of each location associated with each detection of each signal. For example, a location associated with each detection of a plurality of detections of each signal may be determined based on a velocity of a computing/detection device over a period of time associated with each detection. For example, each detection of a plurality of detections of each signal, over the period of time, may be correlated to each other. Thus, the accuracy of the location of each signal (and thus, each network leak) increases with each detection.

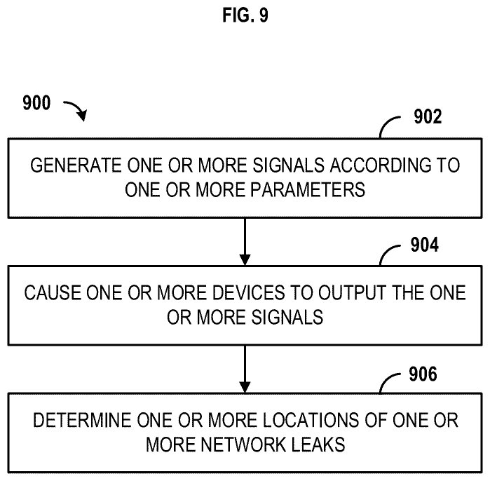

FIG. 9 shows a flowchart of an example method 900 for determining signal leaks within a network. For example, the method 900 may be used to determine one or more network leaks based on upstream data/traffic in an HFC network. At step 902, one or more signals may be generated according to one or more parameters associated with location information and velocity information. The one or more signals may be based on an orthogonal frequency division multiple access upstream data profile (OUDP). Each signal of the one or more signals may comprise a pulse signal comprising two or more pulses output at an interval over a time period. The minimum number of pulses that can be transmitted is two, resulting in a single peak at the detector. Essentially, one pulse within the pulse signal may become the match filter of the next pulse, and thus, enabling the autocorrelation-based detection method to detect the pulse signal without requiring any knowledge of the transmitted signal. The detection method is sensitive to the repetition within the pulse signal. The one or more parameters may comprise at least one of an interval each signal of the one or more signals is output over a period of time, a pulse width of each signal of the one or more signals, a pulse repetition period of each signal of the one or more signals, or a number of pulses of each signal of the one or more signals to output. The location information may comprise information indicative of a location associated with the one or more devices and a density, or quantity, of the one or more devices within the location. In an example, the location may comprise a cable service area wherein the one or more devices are located. The velocity information may comprise information indicative of a velocity associated with the computing device. As an example, the interval that each pulse signal is output may be determined based on the velocity information. As a further example, the parameters may be determined based on the location information. For example, in a dense urban environment where there may be several devices in RF range, in close proximity to a computing/detection device's travel path, a narrow pulse width may be used. In a sparse rural environment where there are few devices in RF range, far away from the computing/detection device's travel path, a wide pulse width may be used.

At step 904, one or more devices may be caused to output the one or more signals over a period of time. At step 906, one or more locations of one or more network leaks may be determined based on the detection of the one or more signals. For example, a location associated with each detection of a plurality of detections of each signal may be determined based on the velocity of the computing device over a period of time associated with each detection. The one or more locations of the one or more network leaks may be determined based on a correlation of each location associated with each detection. For example, each detection of a plurality of detections of each signal, over the period of time, may be correlated to each other. Thus, the accuracy of the location of each signal (and thus, each network leak) increases with each detection.

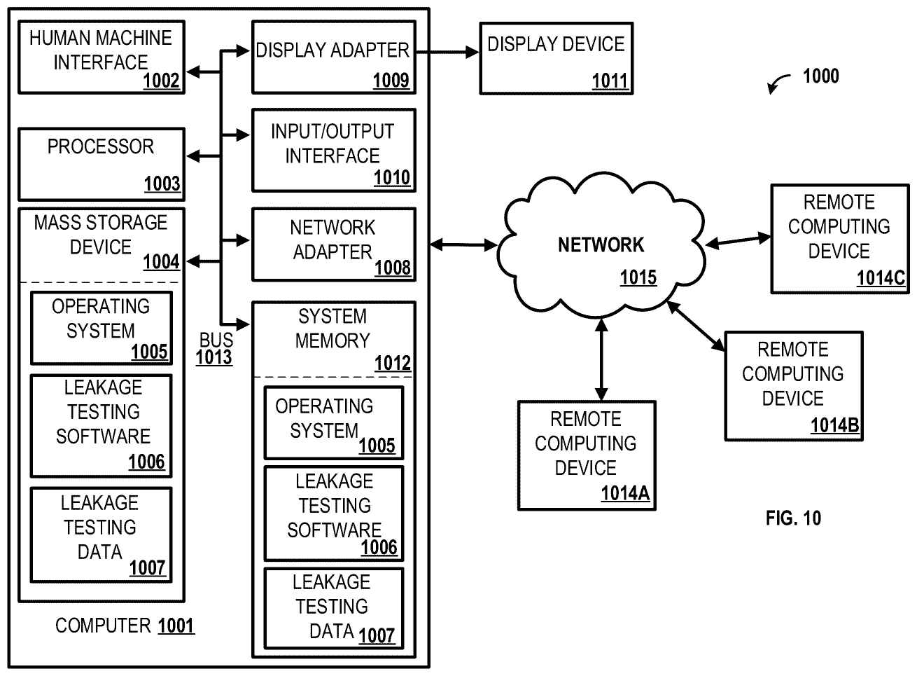

In an example, the methods and systems may be implemented on a computer 1001 as shown in FIG. 10 and described below. By way of example, device 102, network devices 116A-116D, and computing device 104 of FIG. 1 may be a computer 1001 as shown in FIG. 10. Similarly, the methods and systems disclosed can utilize one or more computers to perform one or more functions in one or more locations. FIG. 10 is a block diagram illustrating an exemplary operating environment 1000 for performing the disclosed methods. This exemplary operating environment 1000 is only an example of an operating environment and is not intended to suggest any limitation as to the scope of use or functionality of operating environment architecture. Neither should the operating environment 1000 be interpreted as having any dependency or requirement relating to any one or combination of components illustrated in the exemplary operating environment 1000.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media such as memory storage devices.

Further, one skilled in the art will appreciate that the systems and methods disclosed herein can be implemented via a general-purpose computing device in the form of a computer 1001. The computer 1001 can comprise one or more components, such as one or more processors 1003, a system memory 1012, and a bus 1013 that couples various components of the computer 1001 comprising the one or more processors 1003 to the system memory 1012. In the case of multiple processors 1003, the computer 1001 may utilize parallel computing.

The bus 1013 may comprise one or more of several possible types of bus structures, such as a memory bus, memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1013, and all buses specified in this description can also be implemented over a wired or wireless network connection and one or more of the components of the computer 1001, such as the one or more processors 1003, a mass storage device 1004, an operating system 1005, leakage testing software 1006, leakage testing data 1007, a network adapter 1008, the system memory 1012, an Input/Output Interface 1010, a display adapter 1009, a display device 1011, and a human machine interface 1002, can be contained within one or more remote computing devices 1014A-1014C at physically separate locations, connected through buses of this form, in effect implementing a fully distributed system.

The computer 1001 may operate on and/or comprise a variety of computer-readable media (e.g., non-transitory). Computer-readable media may be any available media that is accessible by the computer 1001 and comprises non-transitory, volatile, and/or non-volatile media, removable and non-removable media. The system memory 1012 has computer-readable media in the form of volatile memory, such as random access memory (RAM), and/or non-volatile memory, such as read-only memory (ROM). The system memory 1012 typically can comprise data such as the leakage testing data 1007 and/or program modules such as the operating system 1005 and the leakage testing software 1006 that are accessible to and/or are operated on by the one or more processors 1003.

The computer 1001 may also comprise other removable/non-removable, volatile/non-volatile computer storage media. The mass storage device 1004 may provide non-volatile storage of computer code, computer-readable instructions, data structures, program modules, and other data for the computer 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read-only memories (ROM), electrically erasable programmable read-only memory (EEPROM), and the like.

Any number of program modules can be stored on the mass storage device 1004, such as, by way of example, the operating system 1005 and the leakage testing software 1006. One or more of the operating system 1005 and the leakage testing software 1006 (or some combination thereof) can comprise elements of the programming and the leakage testing software 1006. The leakage testing data 1007 can also be stored on the mass storage device 1004. The leakage testing data 1007 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 1015.

A user may enter commands and information into the computer 1001 via an input device (not shown). Such input devices may comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 1003 via a human-machine interface 1002 that is coupled to the bus 1013, but may be connected by other interface and bus structures, such as a parallel port, game port, an IEEE 1394 Port (also known as a Firewire port), a serial port, network adapter 1008, and/or a universal serial bus (USB).

A display device 1011 may also be connected to the bus 1013 via an interface, such as a display adapter 1009. It is contemplated that the computer 1001 may have more than one display adapter 1009 and the computer 1001 may have more than one display device 1011. A display device 1011 may be a monitor, an LCD (Liquid Crystal Display), light-emitting diode (LED) display, television, smart lens, smart glass, and/or a projector. In addition to the display device 1011, other output peripheral devices may comprise components such as speakers (not shown) and a printer (not shown) which may be connected to the computer 1001 via Input/Output Interface 1010. Any step and/or result of the methods may be output (or caused to be output) in any form to an output device. Such output may be any form of visual representation, including, but not limited to, textual, graphical, animation, audio, tactile, and the like. The display 1011 and computer 1001 may be part of one device, or separate devices.

The computer 1001 can operate in a networked environment using logical connections to one or more remote computing devices 1014A-1014C. By way of example, a remote computing device 1014A-1014C can be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computer 1001 and a remote computing device 1014A-1014C can be made via a network 1015, such as a local area network (LAN) and/or a general wide area network (WAN). Such network connections can be through the network adapter 1008. The network adapter 1008 can be implemented in both wired and wireless environments. Such networking environments are conventional and commonplace in dwellings, offices, enterprise-wide computer networks, intranets, and the Internet.

Application programs and other executable program components such as the operating system 1005 are illustrated herein as discrete blocks, although it is recognized that such programs and components can reside at various times in different storage components of the computing device 1001, and are executed by the one or more processors 1003 of the computer 1001. An implementation of the leakage testing software 1006 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques comprise, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
determining, based on a velocity of a computing device and a quantity of one or more devices within communication range of the computing device, one or more parameters of one or more signals to be output by the one or more devices;
causing, based on the one or more parameters, the one or more devices to output the one or more signals; and
determining, based on a detection of the one or more signals, one or more locations of one or more network leaks.

2. The method of claim 1, further comprising determining the one or more devices to output the one or more signals based on location information.

3. The method of claim 2, wherein the location information comprises a location associated with the one or more devices.

4. The method of claim 1, wherein each signal of the one or more signals comprises a pulse signal of two or more pulses output at an interval over a period time.

5. The method of claim 1, wherein the one or more parameters comprise at least one of: an interval each signal of the one or more signals is output over a period of time, a pulse width of each signal of the one or more signals, a pulse repetition period of each signal of the one or more signals, or a number of pulses of each signal of the one or more signals to output.

6. The method of claim 5, wherein the interval each signal of the one or more signals is output over the period of time is determined based on the velocity.

7. The method of claim 1, wherein determining, based on the detection of the one or more signals, the one or more locations of the one or more network leaks comprises:
determining, based on the velocity of the computing device over a period of time and a plurality of detections of each signal of the one or more signals over the period of time, a location associated with each detection of the plurality of detections of each signal; and
determining, based on a correlation of each location associated with each detection of each signal, the one or more locations of the one or more network leaks.

8. A method comprising:
determining, by a computing device based on location information and velocity information, one or more parameters associated with one or more signals;
causing, based on the one or more parameters, one or more devices to output the one or more signals; and
determining, based on a detection of the one or more signals, one or more locations of one or more network leaks.

9. The method of claim 8, further comprising receiving the location information and the velocity information from the computing device.

10. The method of claim 8, wherein the location information comprises information indicative of a location associated with the one or more devices and a density associated with the one or more devices within the location, and wherein the velocity information comprises information indicative of a velocity associated with the computing device.

11. The method of claim 8, wherein the one or more parameters comprise at least one of: an interval each signal of the one or more signals is output over a period of time, a pulse width of each signal of the one or more signals, a pulse repetition period of each signal of the one or more signals, or a number of pulses of each signal of the one or more signals to output.

12. The method of claim 11, wherein the interval each signal is output over the period of time is determined based on the velocity information.

13. The method of claim 8, wherein each signal of the one or more signals comprises a pulse signal of two or more pulses output at an interval over a period of time.

14. The method of claim 8, wherein determining, based on the detection of the one or more signals, the one or more locations of the one or more network leaks comprises:
determining, based a velocity of the computing device over a period of time and a plurality of detections of each signal of the one or more signals over the period of time, a location associated with each detection of the plurality of detections of each signal; and
determining, based on a correlation of each location associated with each detection of each signal, the one or more locations of the one or more network leaks.

15. A method comprising:
causing, by a computing device, one or more devices to output one or more signals over a period of time according to one or more parameters associated with location information and velocity information; and
determining, based on a correlation of a location associated with a detection of the one or more signals over the period of time, one or more locations of one or more network leaks.

16. The method of claim 15, further comprising determining, based on a velocity of the computing device over the period of time and a plurality of detections of each signal of the one or more signals over the period of time, a location associated with each detection of the plurality of detections of each signal.

17. The method of claim 16, wherein determining, based on the correlation of the location associated with the detection of the one or more signals over the period of time, the one or more locations of the one or more network leaks comprises determining, based on a correlation of each location associated with each detection of each signal, the one or more locations of the one or more network leaks.

18. The method of claim 15, wherein the location information comprises information indicative of a location associated with the one or more devices and a density associated with the one or more devices within the location, and wherein the velocity information comprises information indicative of a velocity of the computing device.

19. The method of claim 15, wherein the one or more parameters comprise at least one of: an interval each signal of the one or more signals is output over the period of time, a pulse width of each signal of the one or more signals, a pulse repetition period of each signal of the one or more signals, or a number of pulses each signal of the one or more signals to output.

20. The method of claim 15, wherein each signal of the one or more signals comprises two or more pulses output at an interval over the period of time, and wherein the interval is based on a velocity of the computing device.
